(19) United States
(12) Patent Application Publication
(10) Pub. No.: US 2014/0113591 A1
(43) Pub. Date: Apr. 24, 2014

(54) AUTHENTICATION METHOD BETWEEN COMMUNICATION DEVICES

(71) Applicant: ALPS ELECTRIC CO., LTD., Tokyo (JP)

(72) Inventors: Daisuke TAKAI, Tokyo (JP); Yukio OTAKI, Tokyo (JP)

(73) Assignee: ALPS ELECTRIC CO., LTD., Tokyo (JP)

(21) Appl. No.: 14/054,346

(22) Filed: Oct. 15, 2013

(30) Foreign Application Priority Data
Oct. 22, 2012 (JP) 2012-232522

(51) Int. Cl. H04W 12/06

(52) U.S. Cl. CPC H04W 12/06
USPC 455/411

(57) ABSTRACT

In an authentication method between communication devices, the authentication method being used for identifying a communication device to serve as a target of communication among a plurality of communication devices including a first communication device and a second communication device and establishing a connection for communication, the first communication device receives a signal the second communication device transmits, detects first displacement information relating to the positional change of the second communication device, from a change in the intensity of the received signal and a change in the phase thereof, performs first determination by comparing the first displacement information with first held information preliminarily set, and identifies the second communication device as a target of communication on the basis of the result of the first determination.

### CLAIM OF PRIORITY

This application contains subject matter related to and claims the benefit of Japanese Patent Application No. 2012-232522 filed on Oct. 22, 2012, the entire contents of which is incorporated herein by reference.

### BACKGROUND OF THE DISCLOSURE

1. Field of the Disclosure

The present disclosure relates to an authentication method between communication devices, in which communication devices to serve as targets of communication are identified among a plurality of communication devices and a connection used for communication is established, and, in particular, relates to an authentication method between communication devices where a configuration is simple and it may be possible to reliably perform authentication owing to a gesture.

2. Description of the Related Art

In recent years, between a communication terminal such as a mobile phone or a highly-functional portable information terminal (hereinafter, simply referred to as a smartphone) and a personal computer (hereinafter, simply referred to as a PC) with a communication function, or between a plurality of communication devices such as, for example, between communication terminals such as smartphones, there has been an increase in the number of a situation where these communication devices are caused to collaborate with each other and wireless communication such as data transfer is performed. On this occasion, authentication processing called pairing (hereinafter, simply referred to as authentication) becomes necessary where communication devices to serve as targets of communication are identified among a plurality of communication devices and a connection used for communication is established between the communication devices serving as targets. As a method used for performing this authentication owing to a simple operation, attention has been focused on an authentication method where communication devices to serve as targets of communication are identified owing to a predetermined gesture a user makes with holding these communication devices. As such an authentication method, for example, a method such as Japanese Unexamined Patent Application Publication (Translation of POT Application) No. 2006-520546 or Japanese Unexamined Patent Application Publication No. 2009-159066 has been proposed.

In Japanese Unexamined Patent Application Publication (Translation of POT Application) No. 2006-520546, an authentication method in a communication system, as illustrated in FIG. 16, has been proposed, the communication system including a first mobile phone (communication device) and a second mobile phone (communication device). In this method, a hugging state between the first mobile phone and the second mobile phone is detected, and when being in the hugging state has been detected, the first mobile phone and the second mobile phone identify each other as targets of communication. In addition, a data transfer channel used for transferring data is opened between the first mobile phone and the second mobile phone. The first mobile phone and the second mobile phone perform authentication in this way. The hugging state is a state where “the first mobile phone and the second mobile phone are located close to each other and perform the motion of a particular pattern with respect to each other”.

As a method for detecting the hugging state between the first mobile phone and the second mobile phone, for example, the following method has been proposed. First, in a first method, owing to an acceleration sensor within the first mobile phone, the acceleration (motion state) of the first mobile phone is detected. In addition, the detected acceleration is compared with a preliminarily set acceleration/deceleration profile, and hence, it is determined whether or not the hugging state. In addition, in a second method, the first mobile phone measures the electromagnetic field intensity of a reception signal from the second mobile phone, and hence, the relative distance change (motion state) of the first mobile phone with respect to the second mobile phone is detected. In addition, the temporal change of the electromagnetic field intensity of the reception signal is compared with a preliminarily set time function, and hence, it is determined whether or not the hugging state.

In Japanese Unexamined Patent Application Publication No. 2009-159066, an authentication method in a communication system, as illustrated in FIG. 17, has been proposed, the communication system including a transmission device (communication device) and a reception device (communication device). A flowchart on the left side of FIG. 17 is a flowchart illustrating a procedure on a transmission device side. A flowchart on the right side of FIG. 17 is a flowchart illustrating a procedure on a reception device side. In this method, the transmission device outputs, as a probe signal, a sound wave signal (or an electromagnetic wave signal) having a predetermined frequency. In addition, from the Doppler shift (change in frequency) amount of the frequency of the received probe signal, the reception device detects the acceleration (motion state) of the transmission device, and determines whether the transmission device has moved toward the reception device. In addition, on the basis of the determination result, the reception device identifies the transmission device as a target of communication, and establishes a connection between the transmission device and the reception device.

In the first method illustrated in Japanese Unexamined Patent Application Publication (Translation of PCT Application) No. 2006-520546, since the acceleration (motion state) of the first mobile phone is detected by the acceleration sensor within the first mobile phone, a particular element such as the acceleration sensor is necessary, and the configuration of a device becomes complex. In addition, it is difficult to perform authentication with a communication device not including such a particular element.

In the second method illustrated in Japanese Unexamined Patent Application Publication (Translation of PCT Application) No. 2006-520546, the first mobile phone measures the electromagnetic field intensity of a reception signal from the second mobile phone, and hence, the relative distance change (motion state) of the first mobile phone with respect to the second mobile phone is detected. In this method, a particular element such as the acceleration sensor is not necessary. However, since a motion state is only detected owing to the electromagnetic field intensity of the reception signal, it may be possible to only identify a relative distance change between the first mobile phone and the second mobile phone. As a result, since the detectable direction of a motion is limited to one of drawing nigh and moving away, it is difficult to correctly detect a gesture motion, and erroneous determination may easily occur.

In the method illustrated in Japanese Unexamined Patent Application Publication No. 2009-159066, since, from the Doppler shift (change in frequency) amount of a frequency, the reception device detects the acceleration (motion state) of the transmission device, it may be possible to detect, with relatively high accuracy, acceleration (motion state) in a direction toward the reception device or a direction away from the reception device. However, when having moved in a direction vertical to a direction toward the self-device, it is difficult for the transmission device to identify the direction of the movement using only the Doppler shift (change in frequency). As a result, since the detectable direction of a motion is limited, it is difficult to correctly detect a gesture motion, and erroneous determination may easily occur.

These and other drawbacks exist.

### SUMMARY OF THE DISCLOSURE

In view of such a situation of the related art, the present disclosure is made, and provides an authentication method between communication devices where a configuration is simple and it may be possible to reliably perform authentication using a gesture.

So as to solve this problem, an authentication method according to the various embodiments provides an authentication method between communication devices. The authentication method includes identifying a communication device to serve as a target of communication among a plurality of communication devices including a first communication device and a second communication device, and establishing a connection for communication, wherein the first communication device receives a signal the second communication device transmits, detects first displacement information relating to a positional change of the second communication device, from a change in an intensity of the received signal and a change in a phase difference thereof, performs first determination by comparing the first displacement information with first held information preliminarily set, and identifies the second communication device as a target of communication on the basis of a result of the first determination.

In this authentication method, the first communication device receives a signal the second communication device transmits, and detects the first displacement information relating to the positional change of the second communication device, from a change in the intensity of the received signal and a change in the phase difference thereof. Therefore, a particular element such as an acceleration sensor becomes unnecessary, and it may be possible to perform authentication owing to a simple configuration. In addition, since, in addition to a change in the intensity of the received signal, the first communication device also utilizes a change in the phase difference thereof, it may be possible to detect a more complex positional change. For example, in addition to the relative distance change of the second communication device with respect to the first communication device, it may also be possible to detect the relative directional change thereof. As a result, since it may be possible to more correctly detect the positional change of the second communication device, erroneous determination may be reduced. Accordingly, in this authentication method, a configuration is simple and it may be possible to reliably perform authentication using a gesture.

As for an authentication method according to claim 2, in the authentication method according to claim 1, it is preferable that the first displacement information is quantified information relating to a relative distance change and a relative directional change of the second communication device with respect to the first communication device.

In this authentication method, the first displacement information is information relating to the relative distance change and the relative directional change of the second communication device with respect to the first communication device. Therefore, owing to information easily determining motion states such as a change in a distance and a change in a direction, it may be possible for the first communication device to determine whether or not a predetermined gesture has been made. Furthermore, the first displacement information is not a so-called analog electrical signal but digitally quantified information. Therefore, it may be easy to perform a correction so as to enhance the accuracy of detection or it may be easy to process so as to easily compare with other information.

In an authentication method according to various embodiments, the first communication device includes a first array antenna including a plurality of antenna elements and a spacing between the antenna elements adjacent to each other in the first array antenna is set to be less than or equal to a half of a wavelength of a signal the second communication device transmits.

In this authentication method, the first communication device includes the first array antenna including the plural antenna elements. Therefore, when receiving a signal the second communication device transmits, it may be possible to receive a plurality of signals whose phases are shifted in response to a spacing between the antenna elements adjacent to each other. It also may be possible to estimate a direction from which the signal arrives, from a phase difference between such signals. In addition, a spacing between the antenna elements adjacent to each other in the first array antenna is less than or equal to a half of the wavelength of a signal the second communication device transmits. Therefore, since it may be possible to unambiguously estimate a direction from which the signal arrives, it may be easy to estimate the direction. Using such a first array antenna, it may be possible for the first communication device to easily detect the relative directional change of the second communication device with respect to the first communication device, from a change in the phase difference between the received signals.

In various embodiments, the first communication device and the second communication device have close-range communication functions, and the first communication device is put into a close-range communication mode when a power supply has been turned on, and performs communication relating to authentication with the second communication device, owing to close-range communication.

In this authentication method, the first communication device and the second communication device have the close-range communication functions, and the first communication device performs communication relating to authentication with the second communication device, owing to the close-range communication. Therefore, in a communication system including another communication device in addition to the first communication device and the second communication device, even if the other communication device exists in the vicinity of the first communication device, it may be possible to reduce the influence of an electromagnetic wave on the other communication device. Furthermore, when the power supply has been turned on, the first communication device is put into the close-range communication mode. Therefore, it is not necessary for a user to set to the close-range communication mode each time before an operation for authentication is started, and an operation may become simple.

In various embodiments, the first communication device transmits, to the second communication device, a query message used for requesting a user to make a predetermined gesture with holding the second communication device, the second communication device requests the user to make the predetermined gesture, on the basis of the query message received from the first communication device, and the first communication device detects the first displacement information from the positional change of the second communication device, the positional change of the second communication device being associated with the predetermined gesture.

In this authentication method, the first communication device transmits, to the second communication device, the query message used for requesting the predetermined gesture from the user, the predetermined gesture being made with the second communication device held. In addition, on the basis of the query message received from the first communication device, the second communication device requests the predetermined gesture from the user. Therefore, in a communication system including another communication device in addition to the first communication device and the second communication device, even if a plurality of communication devices to serve as targets of authentication exist and authentication due to a plurality of gestures becomes necessary, the user does not mistake a gesture used for performing authentication between the first communication device and the second communication device.

In various embodiments, the second communication device receives a signal the first communication device transmits, detects second displacement information relating to a positional change of the first communication device, from a change in an intensity of the received signal and a change in a phase difference thereof, performs second determination by comparing the second displacement information with second held information preliminarily set, and identifies the first communication device as a target of communication on the basis of a result of the second determination, and by at least one communication device of the first communication device and the second communication device identifying the other communication device as a target of communication, authentication between the first communication device and the second communication device is established.

In this authentication method, in addition to the first communication device, the second communication device also receives a signal the first communication device transmits, detects the second displacement information relating to the positional change of the first communication device, from a change in the intensity of the received signal and a change in the phase difference thereof, performs the second determination by comparing the second displacement information with the preliminarily set second held information, and identifies the first communication device as a target of communication on the basis of the result of the second determination. In addition, at least one communication device of the first communication device and the second communication device identifies the other communication device as a target of communication, and hence, authentication between the first communication device and the second communication device is established. Therefore, even if one of the first communication device and the second communication device has failed in identifying a target of communication, when the other has succeeded, authentication between the first communication device and the second communication device is established. As a result, it may be possible to more reliably perform authentication.

In various embodiments, the first displacement information is quantified information relating to a relative distance change and a relative directional change of the second communication device with respect to the first communication device and the second displacement information is quantified information relating to a relative distance change and a relative directional change of the first communication device with respect to the second communication device.

In this authentication method, the first displacement information is information relating to the relative distance change and the relative directional change of the second communication device with respect to the first communication device. In addition, the second displacement information is information relating to the relative distance change and the relative directional change of the first communication device with respect to the second communication device. Therefore, owing to information easily determining motion states such as a change in a distance and a change in a direction, it may be possible for the first communication device and the second communication device to determine whether or not a predetermined gesture has been made. Furthermore, the first displacement information and the second displacement information are not so-called analog electrical signals but pieces of digitally quantified information. Therefore, it may be easy to perform a correction so as to enhance the accuracy of detection or it may be easy to process so as to easily compare with other information.

In various embodiments, the first communication device includes a first array antenna including a plurality of antenna elements, a spacing between the antenna elements adjacent to each other in the first array antenna is set to be less than or equal to a half of a wavelength of a signal the second communication device transmits, the second communication device includes a second array antenna including a plurality of antenna elements, and a spacing between the antenna elements adjacent to each other in the second array antenna is set to be less than or equal to a half of a wavelength of a signal the first communication device transmits.

In this authentication method, the first communication device includes the first array antenna including the plural antenna elements. Therefore, when receiving a signal the second communication device transmits, it may be possible to receive at least two signals whose phases are shifted in response to a spacing between the antenna elements adjacent to each other. It may be possible to estimate a direction from which the signal arrives, from a phase difference between such signals. Furthermore, a spacing between the antenna elements adjacent to each other in the first array antenna is less than or equal to a half of the wavelength of a signal the second communication device transmits. Therefore, since it may be possible to unambiguously estimate a direction from which the signal arrives, it may be possible to easily estimate the direction. Using such a first array antenna, it may be possible for the first communication device to easily detect the relative directional change of the second communication device with respect to the first communication device, from a change in the phase difference between the received signals.

In the same way, the second communication device includes the second array antenna including the plural antenna elements. Furthermore, a spacing between the antenna elements adjacent to each other in the second array antenna is less than or equal to a half of the wavelength of a signal the first communication device transmits. Using such a second array antenna, it may be possible for the second communication device to easily detect the relative directional change of the first communication device with respect to the second communication device, from a change in the phase difference between the received signals.

In various embodiments, the second communication device performs reception when the first communication device performs transmission, the first communication device performs reception when the second communication device performs transmission, and the first communication device and the second communication device individually repeat transmission and reception with respect to each other in a time division manner.

In this authentication method, the first communication device and the second communication device repeat transmission and reception with respect to each other in a time division manner. Therefore, it may be possible for the first communication device and the second communication device to continuously monitor the intensities and the phases of received signals. As a result, it may be possible to reduce erroneous determination due to an omission of determination. In addition, using the same frequency, it may be possible for the first communication device and the second communication device to perform transmission and reception. Therefore, it may be possible for the first communication device and the second communication device to estimate directions from which received signals arrive, under the operation condition that the same frequency is used. As a result, it may become easy to detect the first displacement information and the second displacement information.

As for an authentication method according to claim 10, in the authentication method according to claim 6, it is preferable that the positional change of the first communication device and the positional change of the second communication device are made owing to a predetermined gesture a user makes with holding the first communication device and the second communication device and the predetermined gesture is such a gesture that the first communication device and the second communication device make substantially point-symmetric motions with respect to each other with one point as a center, the one point existing in a neighborhood space of the user.

In this authentication method, the positional change of the first communication device and the positional change of the second communication device are made owing to a predetermined gesture the user makes with holding the first communication device and the second communication device, and the predetermined gesture is such a gesture that the first communication device and the second communication device make substantially point-symmetric motions with respect to each other with one point as a center, the one point existing in the neighborhood space of the user. Therefore, the relative distance change of the second communication device with respect to the first communication device becomes a change approximately twice as large as a case where only the second communication device has moved. In addition, the relative distance change of the first communication device with respect to the second communication device becomes a change approximately twice as large as a case where only the first communication device has moved. As a result, even if the gesture of the user is a small motion, it may become easy to detect the first displacement information and the second displacement information. Furthermore, the first displacement information and the second displacement information become pieces of similar information whose distance changes are approximately equal to each other and whose directional changes are opposite in direction to each other. As a result, since, using the first displacement information and the second displacement information, which are similar to each other, it may be possible to perform the determination of a gesture, the determination may become simple.

### BRIEF DESCRIPTION OF THE DRAWINGS

FIG. 1 is an explanatory diagram illustrating a configuration of a communication system according to an exemplary embodiment of the present disclosure;

FIGS. 2A and 2B are explanatory diagrams schematically illustrating layout of communication devices illustrated in FIG. 1;

FIG. 3 is a block diagram illustrating a configuration of a first communication device illustrated in FIG. 1;

FIG. 4 is an explanatory diagram illustrating an example of a gesture motion according to an exemplary embodiment of the present disclosure;

FIG. 5 is an explanatory diagram illustrating an estimation principle for an arrival direction of a signal according to embodiments of the present disclosure;

FIGS. 6A and 6B are explanatory diagrams illustrating a relationship between an angle θ and a phase difference Δφ illustrated in FIG. 5;

FIG. 7 is a flowchart illustrating a procedure for authentication according to an exemplary embodiment of the present disclosure;

FIG. 8 is an explanatory diagram illustrating a configuration of a communication system according to an exemplary embodiment of the present disclosure;

FIGS. 9A and 95 are explanatory diagrams schematically illustrating layout of communication devices illustrated in FIG. 8;

FIG. 10 is a flowchart illustrating a procedure for authentication according to an exemplary embodiment of the present disclosure;

FIG. 11 is an explanatory diagram illustrating a configuration of a communication system according to an exemplary embodiment of the present disclosure;

FIGS. 12A and 125 are explanatory diagrams schematically illustrating layout of communication devices illustrated in FIG. 11;

FIG. 13 is a block diagram illustrating a configuration of a second communication device illustrated in FIG. 11;

FIG. 14 is an explanatory diagram illustrating an example of a gesture motion according to an exemplary embodiment of the present disclosure;

FIG. 15 is a flowchart illustrating a procedure for authentication according to the an exemplary embodiment of the present disclosure;

FIG. 16 is a flowchart illustrating a procedure for authentication according to Japanese Unexamined Patent Application Publication (Translation of PCT Application) No. 2006-520546; and

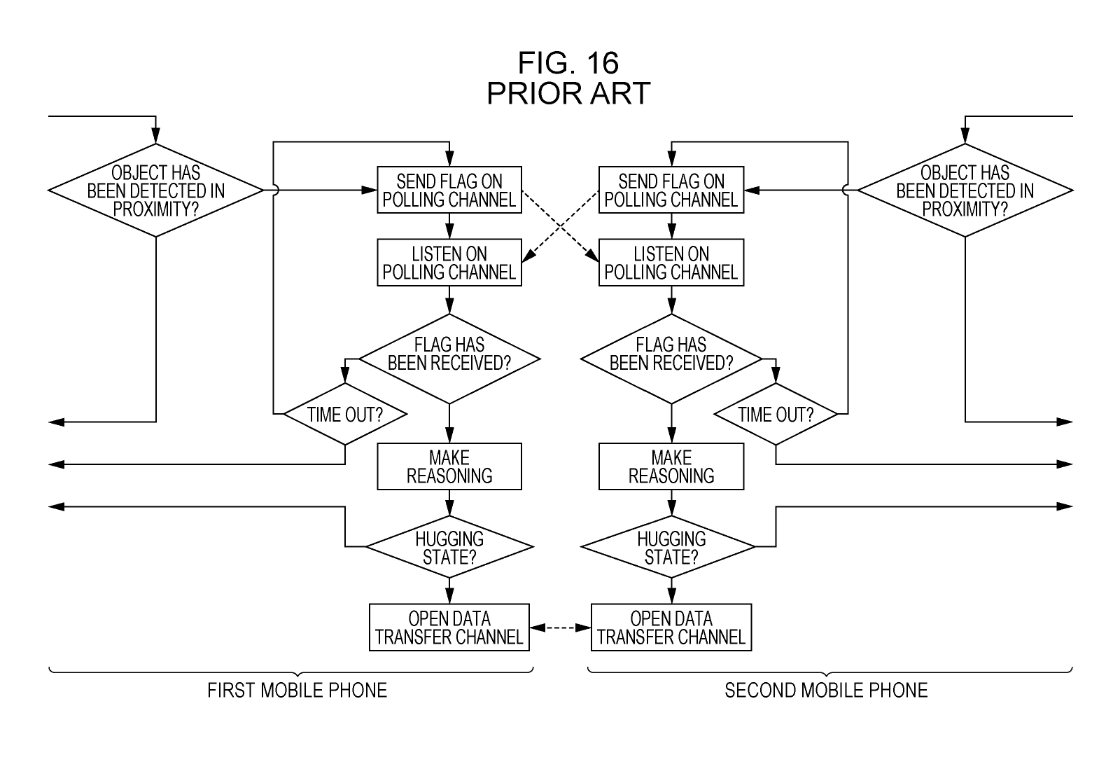

FIG. 17 is a flowchart illustrating a procedure for authentication according to Japanese Unexamined Patent Application Publication No. 2009-159066.

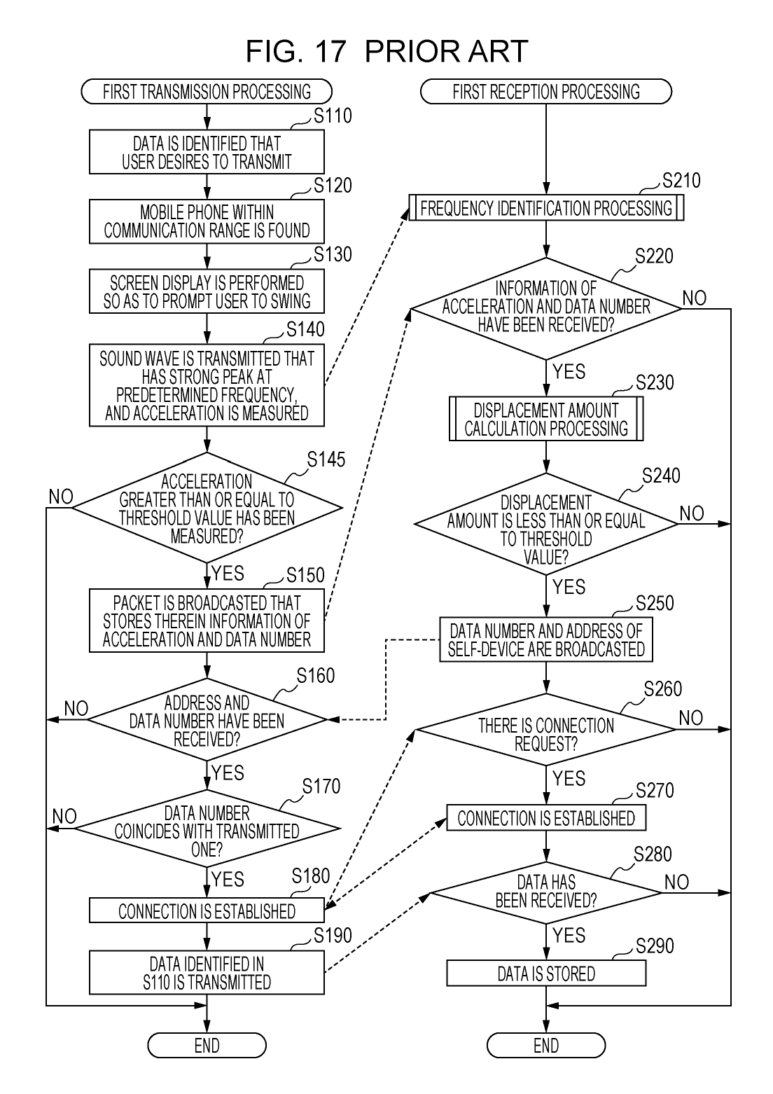

### DESCRIPTION OF THE PREFERRED EMBODIMENTS

The following description is intended to convey a thorough understanding of the embodiments described by providing a number of specific embodiments and details involving an authentication method between communication devices. It should be appreciated, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending on specific design and other needs.

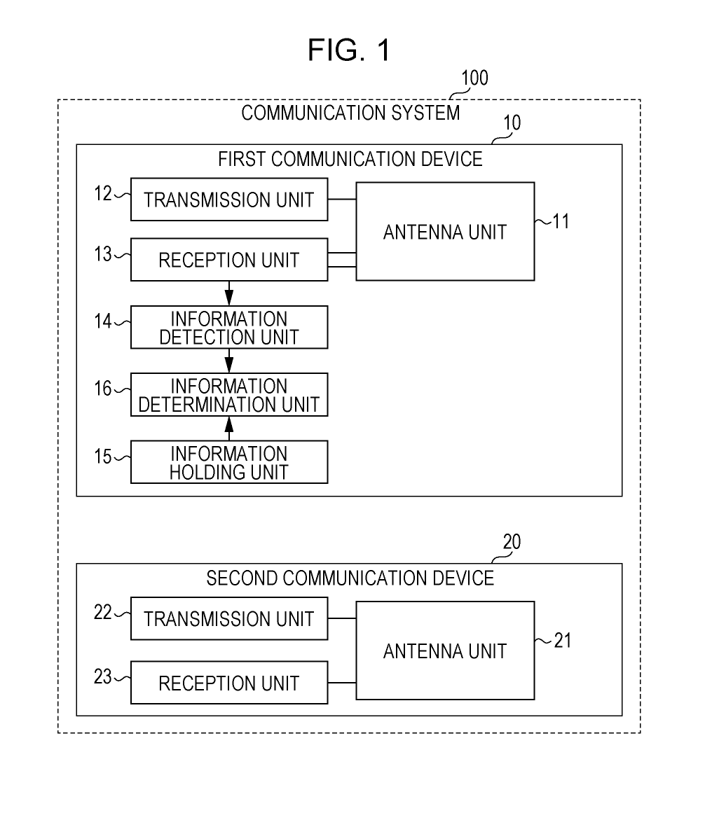

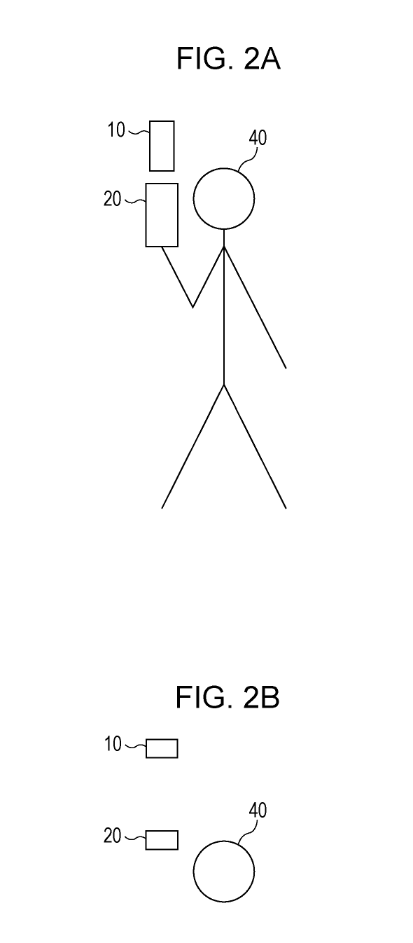

FIG. 1 is an explanatory diagram illustrating the configuration of a communication system according to the an exemplary embodiment according to the present disclosure. FIGS. 2A and 2B are explanatory diagrams schematically illustrating the layout of exemplary communication devices illustrated in FIG. 1. FIG. 2A is a side view, and FIG. 2B is a top view.

As illustrated in FIG. 1 and FIGS. 2A and 2B, a communication system 100 according to an embodiment may include a first communication device 10 and a second communication device 20. A user 40 may stand in front of the first communication device 10 (on the lower side of FIG. 2B) with holding the second communication device 20 in the user's left hand (on the left side of FIG. 2A). In this way, the first communication device 10 and the second communication device 20 may be laid out so as to substantially face each other.

As the first communication device 10, a communication device may be used that wirelessly transfers a large amount of data at high speed owing to wireless communication, in the same way as, for example, a smartphone or a PC. As the second communication device 20, a communication terminal such as, for example, the smartphone or a mobile phone may be used. It may be possible for the first communication device 10 and the second communication device 20 to perform wireless communication such as the transfer of data, in cooperation with each other. In addition, when wireless communication is performed, it may be possible to perform authentication processing (authentication) called pairing, owing to a predetermined gesture the user 40 makes with holding the second communication device 20. In addition to this, in the authentication processing, the first communication device 10 and the second communication device 20 may identify each other as targets of communication and establish a connection for communication.

The first communication device 10 may include an antenna unit 11, a transmission unit 12, and a reception unit 13. The transmission unit 12 and the reception unit 13 may be individually connected to a signal processing circuit (not illustrated). In addition, predetermined wireless communication may be performed using, for example, the antenna unit 11, the transmission unit 12, and the reception unit 13. The first communication device 10 further may include an information detection unit 14, an information holding unit 15, and an information determination unit 16. In addition, authentication may be performed using the information detection unit 14, the information holding unit 15, and the information determination unit 16. The second communication device 20 may include an antenna unit 21, a transmission unit 22, and a reception unit 23. The transmission unit 22 and the reception unit 23 may be individually connected to a signal processing circuit (not illustrated). In addition, predetermined wireless communication may be performed using the antenna unit 21, the transmission unit 22, and the reception unit 23.

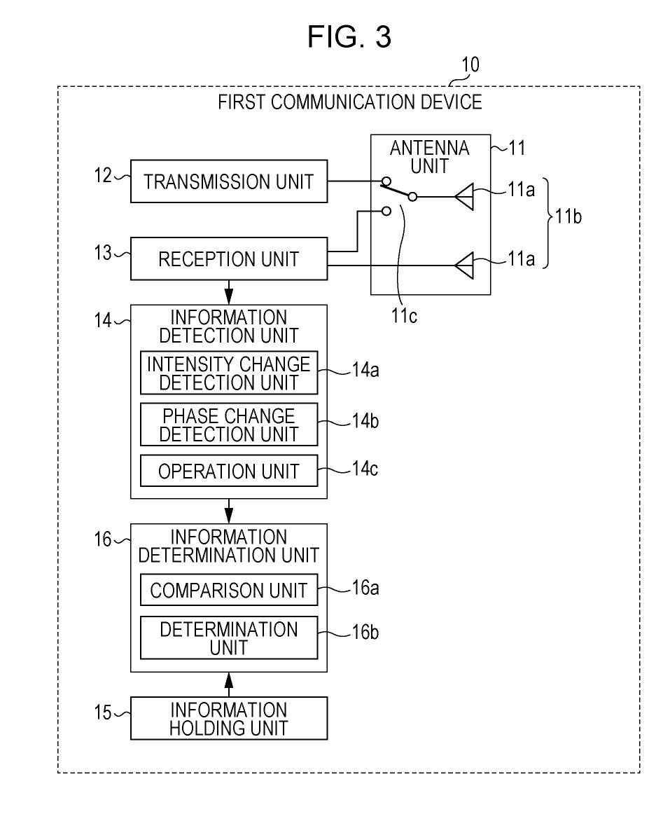

FIG. 3 is a block diagram illustrating the configuration of the first communication device illustrated in FIG. 1. As illustrated in FIG. 3, the antenna unit 11 may include an array antenna 11b (e.g., first array antenna) including a plurality of antenna elements 11a, and a switching circuit 11c switching between a connection at the time of transmission and a connection at the time of reception. A spacing between the antenna elements 11a adjacent to each other in the array antenna 11b (hereinafter, simply referred to as an interelement spacing) may be set to be less than or equal to a half of the wavelength of a signal the second communication device 20 transmits.

The switching circuit 11c may switch connections between the antenna elements 11a and the transmission unit 12 and the reception unit 13 at the time of transmission and the time of reception. At the time of transmission, one antenna element 11a from among the plural antenna elements 11a may be connected to the transmission unit 12. The antenna element 11a may convert an electrical signal output from the transmission unit 12, into an electromagnetic wave signal (hereinafter, simply referred to as a transmission signal) to be transmitted to another communication device. At the time of reception, a connection between the antenna element 11a and the transmission unit 12 may be released. In addition, the plural antenna elements 11e may be connected to the reception unit 13. The plural antenna elements 11a may convert an electromagnetic wave signal (hereinafter, referred to as a reception signal) received from another communication device, into an electrical signal to be input to the reception unit 13. At this time, the plural antenna elements 11a may receive a plurality of signals whose phases are shifted in response to a direction (hereinafter, referred to as an arrival direction) from which the signal arrives.

In this way, the antenna unit 11 may convert the electrical signal output from the transmission unit 12, into a transmission signal for another communication device. In addition, the antenna unit 11 may convert a reception signal from another communication device, into the electrical signal to be input to the reception unit 13. The reception unit 13 may obtain, from the plural antenna elements 11a, the plural signals whose phases are shifted in response to a direction from which the signal arrives.

Information detection unit 14 may include an intensity change detection unit 14a, a phase change detection unit 14b, and an operation unit 14c. In addition, the information detection unit 14 may be connected to the reception unit 13, and obtains, from the reception unit 13, information relating to the intensity and the phase of the reception signal. The intensity change detection unit 14a may monitor the information relating to the intensity of the reception signal, and may detect a change in the intensity of the reception signal. The phase change detection unit 14b may monitor the information relating to the phase difference of the reception signal, from the plural signals whose phases are shifted in response to a direction from which the signal arrives, and may detect a change in the phase difference of the reception signal. The operation unit 14c may calculate first displacement information, from the information of the intensity change the intensity change detection unit 14a has detected and the information of the phase difference change the phase change detection unit 14b has detected. In the information detection unit 14, the first displacement information may be detected in this way.

The first displacement information may be information relating, for example, to the actual positional change of the second communication device 20 with respect to the first communication device 10. In an embodiment, as the first displacement information, information may be used that relates to the relative distance change and the relative directional change of the second communication device 20 with respect to the first communication device 10, which may be associated with a predetermined gesture the user 40 makes. In addition, the first displacement information may not be a so-called analog electrical signal, and may be digitally quantified information. In addition, the first displacement information also may be corrected so as to enhance the accuracy of detection, or the information thereof may also be processed so as to be easily compared with other information.

The information holding unit 15 holds first held information preliminarily set. Such holding of information may be performed using, for example, a method causing a recording device such as a hard disk device to record, a method causing a storage device such as a semiconductor memory device to store, or a method carrying out an operation each time in accordance with a predetermined procedure.

The first held information is information to be compared with the first displacement information. In the present embodiment, as the first held information, information may be used that relates to the relative distance change and the relative directional change of the second communication device 20 with respect to the first communication device 10, which are anticipated to serve as a predetermined gesture. In addition, like the first displacement information, the first held information may be digitally quantified information.

The information determination unit 16 may include a comparison unit 16a and a determination unit 16b. In addition, the information determination unit 16 may be connected to the information detection unit 14, and may obtain the first displacement information. In addition, the information determination unit 16 may be connected to the information holding unit 15, and may obtain the first held information. The comparison unit 16a may compare the first displacement information and the first held information, which have been obtained, with each other. From the result of a comparison the comparison unit 16a has performed, the determination unit 16b may determine whether or not a predetermined gesture has been made, and may determine whether or not to be connectable to the second communication device 20.

Here, in the present embodiment, the comparison unit 16a may compare an actual positional change, associated with a predetermined gesture, with a positional change anticipated to serve as the predetermined gesture. In addition, when a difference between the actual positional change and the anticipated positional change is smaller than a predetermined range, the determination unit 16b may determine that the predetermined gesture has been made, and may determine to be “connectable”. In addition, if this is not the case, the determination unit 16b may determine to be “non-connectable”. In this way, the information determination unit 16 may determine whether or not to be connectable to the second communication device 20.

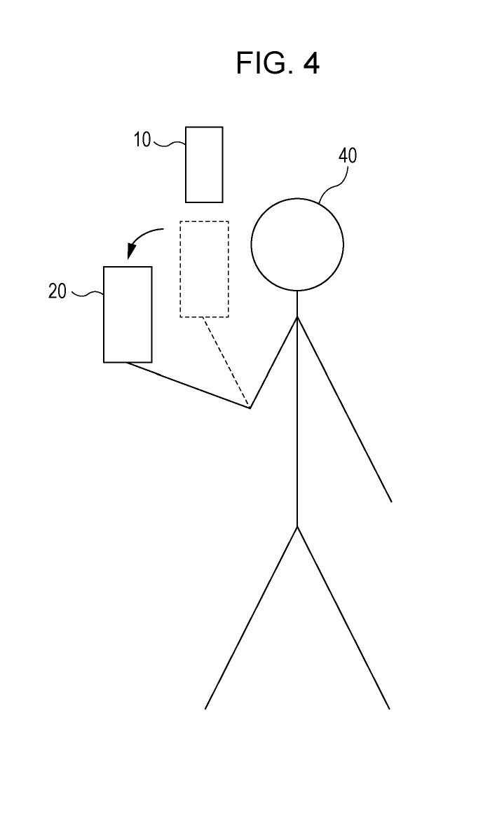

FIG. 4 is an explanatory diagram illustrating an example of a gesture motion according to various embodiments of the present disclosure. As illustrated in FIGS. 2A and 2B, the user 40 may stand in front of the first communication device 10 (on the lower side of FIG. 2B) with holding the second communication device 20 in the user's left hand (on the left side of FIG. 2A). A signal may be transmitted from the second communication device 20, and the first communication device 10 receives that signal. In addition, as illustrated in FIG. 4, the user 40 may make a gesture such as swinging down the second communication device 20 toward the left side.

Along with such a gesture of the user 40, the position of the second communication device 20 changes. In addition, the relative distance and the relative direction of the second communication device 20 with respect to the first communication device 10 change. In response to the changes, the intensity and the phase difference of a signal the first communication device 10 receives from the second communication device 20 also change. At this time, since, using the array antenna 11b in the antenna unit 11, the first communication device 10 may receive the signal the second communication device 20 transmits, it may be possible to detect a change in the intensity of the reception signal and a change in the phase difference thereof. In addition, from the change in the intensity of the reception signal and the change in the phase difference thereof, it also may be possible to estimate the relative distance change and the relative directional change of the second communication device 20 with respect to the first communication device 10.

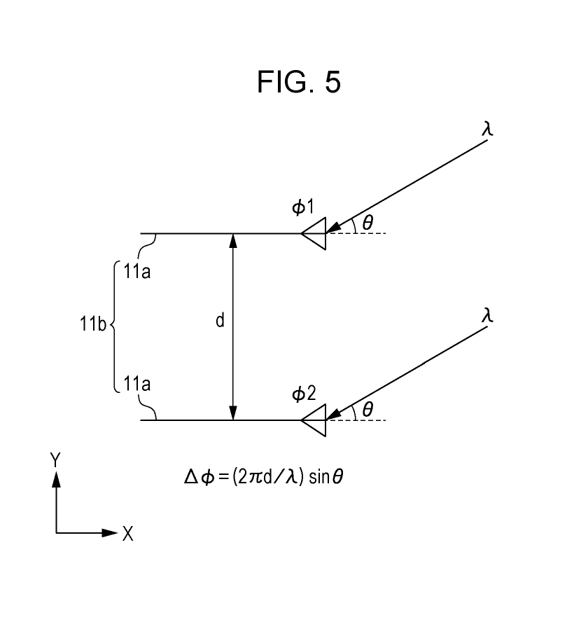

FIG. 5 is an explanatory diagram illustrating an estimation principle for the arrival direction of a signal according to the present disclosure. FIG. 5 is an example when the array antenna 11b includes the two antenna elements 11a.

As illustrated in FIG. 5, the array antenna 11b in the first communication device 10 may include the two antenna elements 11e. The two antenna elements 11a may be disposed along a y-axis direction (the upper direction of FIG. 5), and the leading ends of the two antenna elements 11a may be caused to face in an x-axis direction (the right direction of FIG. 5). In addition, the array antenna 11b may receive an electromagnetic wave signal the second communication device 20 transmits, the electromagnetic wave signal having a wavelength 2. The interelement spacing d of the array antenna 11b may be set to be less than or equal to a half of the wavelength λ. The arrival direction of the signal may be inclined at an angle θ toward a y-axis direction side with respect to the x-axis direction.

In accordance with the interelement spacing d, the angle θ, and the wavelength λ, the two antenna elements 11a individually may receive signals whose phases are shifted. When it is assumed that the phases of the signals the two antenna elements 11a receive are individually φ1 and φ2, a phase shift (hereinafter, referred to as a phase difference) Δφ between the phase φ1 and the phase φ2 is expressed as Δφ=(2πd/λ)sin θ. Using this expression, it may be possible to estimate the angle θ from the phase difference Δφ of the reception signal, and it may be possible to estimate the arrival direction of the signal.

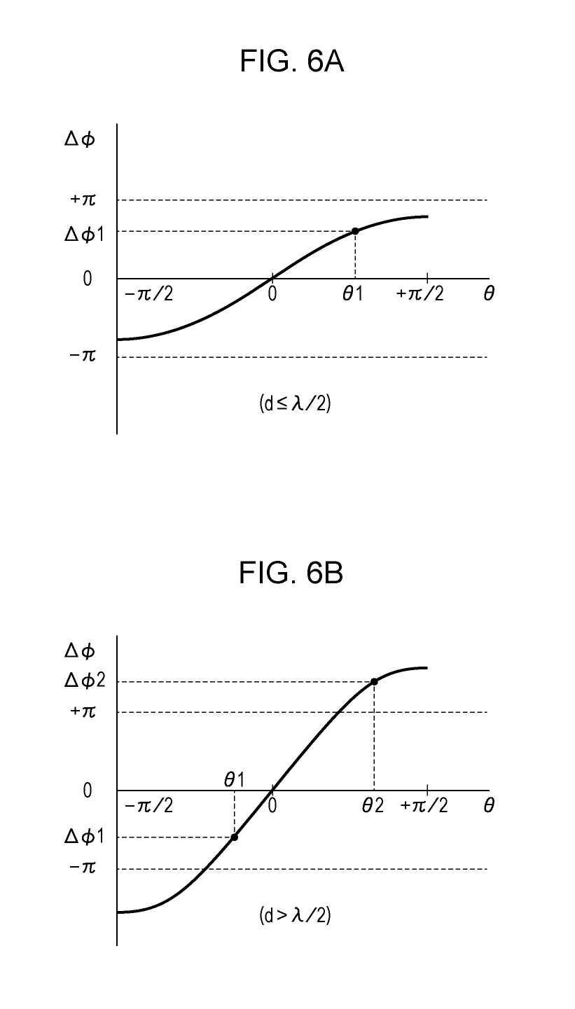

FIG. 6A is an explanatory diagram when the interelement spacing d is less than or equal to a half of the wavelength λ (d≦λ/2). FIG. 6B is an explanatory diagram when the interelement spacing d is larger than a half of the wavelength λ (d>λ/2).

When the interelement spacing d is less than or equal to a half of the wavelength λ (d≦λ/2), the phase difference Δφ changes with drawing a curved line called a sine curve within the range of −π to +π, in response to a change in the angle θ in the range of −π/2 to +π/2, as illustrated in FIG. 6A. In addition, an angle θ1 corresponds to an arbitrary phase difference Δφ1, on a one-to-one basis. Therefore, it may be possible to unambiguously estimate the angle θ from the phase difference Δφ of the reception signal, and as a result, it may be possible to easily estimate the arrival direction of the signal.

However, if the interelement spacing d is larger than a half of the wavelength λ (d>λ/2), the change rate of the phase difference Δφ with respect to a change in the angle θ increases, as illustrated in FIG. 6B. In addition, in response to a change in the angle θ in the range of −π/2 to +π/2, the phase difference Δφ changes beyond the range of −π to +π. Therefore, a case occurs where a phase difference Δφ1 corresponding to an angle θ1 and a phase difference Δφ2 simultaneously exist, the phase difference Δφ2 corresponding to an angle θ2 different from the angle θ1 and satisfying Δφ2=Δφ1+2π. Since it is difficult to distinguish this phase difference Δφ1 from this phase difference Δφ2, it is difficult to unambiguously estimate the angle θ from the phase difference Δφ. Therefore, it may become difficult to estimate the arrival direction of the signal from the phase difference Δφ of the reception signal. Accordingly, the interelement spacing d may be less than or equal to a half of the wavelength λ (d≦λ/2).

In the first communication device 10, using such a principle as described above, the relative direction of the second communication device 20 with respect to the first communication device 10 may be estimated from the phase difference of the reception signal. In addition, the relative directional change of the second communication device 20 with respect to the first communication device 10 may be estimated from a change in the phase difference of the reception signal. In addition, since a method has existed that is used for detecting the relative distance change of the second communication device 20 with respect to the first communication device 10 from a change in the intensity of the reception signal, the description thereof will be omitted.

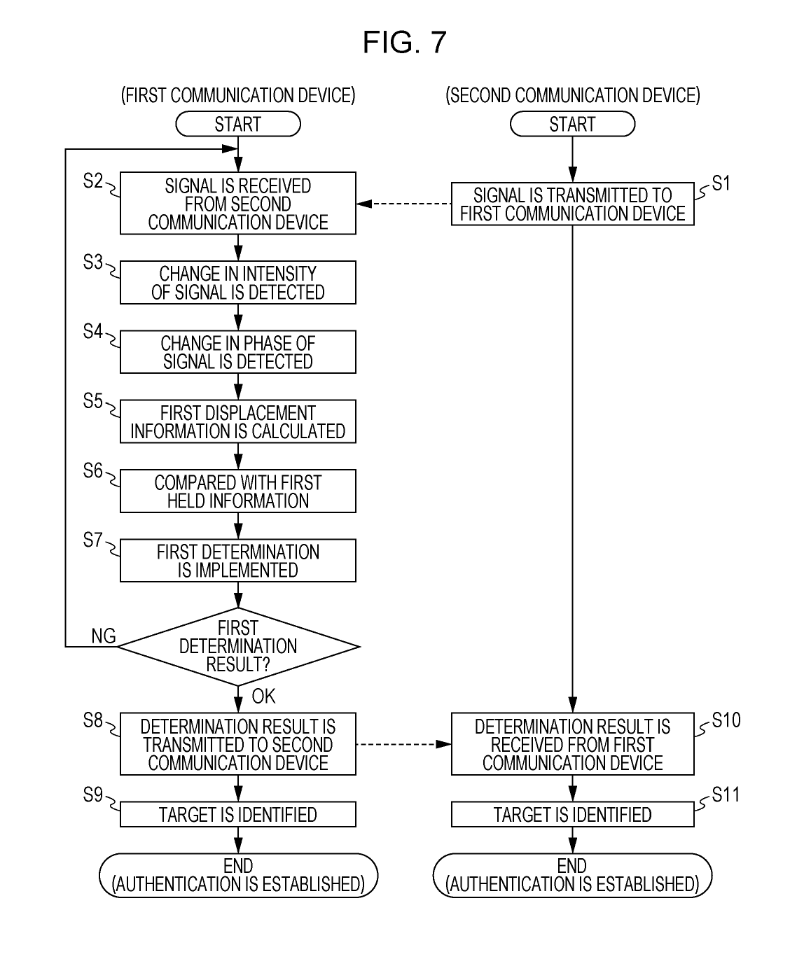

Next, a procedure for authentication will be described using FIG. 7. FIG. 7 is a flowchart illustrating a procedure for authentication according an embodiment of the present disclosure.

As illustrated in FIG. 7, first, the second communication device 20 may transmit a signal to the first communication device 10 (step S1). Next, in response to the step S1, the first communication device 10 may receive the signal from the second communication device 20 (step S2). In addition, along with a predetermined gesture the user 40 makes, the intensity and the phase of the signal the first communication device 10 receives change.

Next, the intensity change detection unit 14a in the information detection unit 14 may detect a change in the intensity of the reception signal (step S3). Next, the phase change detection unit 14b in the information detection unit 14 may detect a change in the phase difference of the reception signal (step S4). Next, the operation unit 14c in the information detection unit 14 may calculate the first displacement information, from a change in the intensity of the reception signal and a change in the phase difference thereof (step S5). Next, the comparison unit 16a in the information determination unit 16 may compare the first displacement information with the first held information (step S6). Next, the determination unit 16b in the information determination unit 16 may implement first determination used for determining whether or not to be connectable to the second communication device 20, from a comparison result in the step S6 (step S7).

When the first determination result obtained in the step S7 is “OK” (pairing is possible), the first communication device 10 may transmit the first determination result to the second communication device 20 (step S8). Next, the first communication device 10 may identify the second communication device 20 as a target of communication (step S9).

In response to the step S8, the second communication device 20 may receive the first determination result from the first communication device 10 (step S10). Next, the second communication device 20 may identify the first communication device 10 as a target of communication (step S11). In addition, authentication has been established between the first communication device 10 and the second communication device 20, and the wireless transfer of data may be started.

In accordance with such a procedure as described above, the first communication device 10 and the second communication device 20 perform authentication.

In an authentication method according to an embodiment, the first communication device 10 may receive a signal the second communication device 20 transmits, and may detect the first displacement information relating to the positional change of the second communication device 20, from a change in the intensity of the received signal and a change in the phase difference thereof. Therefore, a particular element such as an acceleration sensor may become unnecessary, and it may be possible to perform authentication owing to a simple configuration. In addition, since, in addition to a change in the intensity of the received signal, the first communication device 10 also utilizes a change in the phase difference thereof, it may be possible to detect a more complex positional change. For example, in addition to the relative distance change of the second communication device 20 with respect to the first communication device 10, it also may be possible to detect the relative directional change thereof. As a result, since it may be possible to more correctly detect the positional change of the second communication device 20, erroneous determination may be reduced. Accordingly, in this authentication method, a configuration may be simple and it may be possible to reliably perform authentication using a gesture.

In addition, in the authentication method according to the present embodiment, the first displacement information is information relating to the relative distance change and the relative directional change of the second communication device 20 with respect to the first communication device 10. Therefore, owing to information easily determining motion states such as a change in a distance and a change in a direction, it may be possible for the first communication device 10 to determine whether or not a predetermined gesture has been made. Furthermore, the first displacement information is not a so-called analog electrical signal but digitally quantified information. Therefore, it may be easy to perform a correction so as to enhance the accuracy of detection or it may be easy to process so as to easily compare with other information.

In addition, in the authentication method according to an embodiment, the first communication device 10 may include the array antenna 11b (first array antenna) including the plural antenna elements 11a. Therefore, when receiving a signal the second communication device 20 transmits, it may be possible to receive a plurality of signals whose phases are shifted in response to a spacing between the antenna elements 11a adjacent to each other. It may be possible to estimate a direction from which the signal arrives, from a phase difference between such signals. In addition, a spacing between the antenna elements 11a adjacent to each other in the array antenna 11b is less than or equal to a half of the wavelength of a signal the second communication device 20 transmits. Therefore, since it may be possible to unambiguously estimate a direction from which the signal arrives, it may be possible to easily estimate the direction. Using such an array antenna 11b, it may be possible for the first communication device 10 to easily detect the relative directional change of the second communication device 20 with respect to the first communication device 10, from a change in the phase difference between the received signals.

Hereinafter, an embodiment according to the present disclosure will be described with reference to drawings. In addition, the same symbol is assigned to a common portion shared with other disclosed embodiments, and the description thereof is omitted.

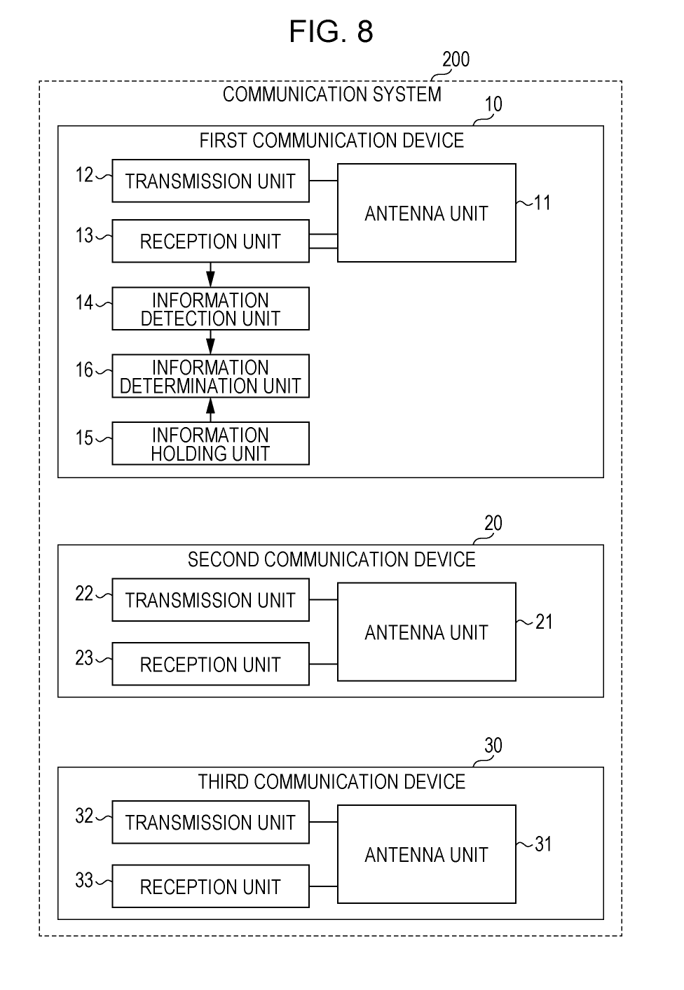

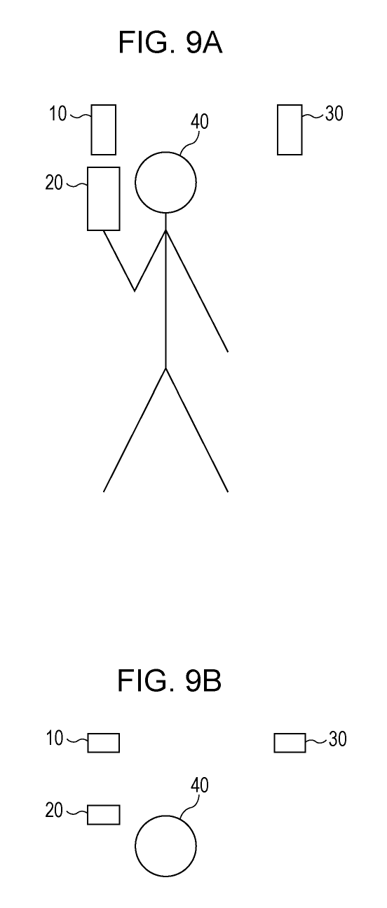

First, the configuration of a communication system to which an authentication method according to the present embodiment is applied will be described using FIG. 8 and FIGS. 9A and 9B. FIG. 8 is, an explanatory diagram illustrating the configuration of a communication system according to the second embodiment in the present invention. FIGS. 9A and 9B are explanatory diagrams illustrating the layout of communication devices illustrated in FIG. 8. FIG. 9A is a side view, and FIG. 9B is a top view.

As illustrated in FIG. 8 and FIGS. 9A and 9B, a communication system 200 according to the an exemplary embodiment includes the first communication device 10, the second communication device 20, and a third communication device 30. The user 40 may stand in front of the first communication device 10 (on the lower side of FIG. 98) with holding the second communication device 20 in the user's left hand (on the left side of FIG. 9A). In this way, the first communication device 10 and the second communication device 20 may be laid out so as to substantially face each other. The third communication device 30 may be laid out on the right side of the first communication device 10 (on the right side of FIG. 9A). In addition, a distance between the first communication device 10 and the second communication device 20 may fall within a close range of about several centimeters. A distance between the first communication device 10 and the third communication device 30 may be longer than the distance between the first communication device 10 and the second communication device 20.

As the first communication device 10, a communication device such as, for example, a smartphone or a PC may be used. As the second communication device 20 and the third communication device 30, communication terminals such as, for example, the smartphones or mobile phones may be used. It may be possible for the first communication device 10 and the second communication device 20 to perform wireless communication such as the transfer of data, in cooperation with each other. In addition, when wireless communication is performed, it may be possible to perform authentication owing to a predetermined gesture the user 40 makes with holding the second communication device 20. In the same way, it may also be possible for the first communication device 10 and the third communication device 30 to perform wireless communication such as the transfer of data, in cooperation with each other. In addition, when wireless communication is performed, it may be possible to perform authentication owing to a predetermined gesture the user 40 makes with holding the third communication device 30. In the present embodiment, an authentication method will be described that is performed when the first communication device 10 and the second communication device 20 communicate with each other and the first communication device 10 and the third communication device 30 do not communicate with each other.

The first communication device 10 may include the antenna unit 11, the transmission unit 12, and the reception unit 13. The transmission unit 12 and the reception unit 13 may be individually connected to a signal processing circuit not illustrated. In addition, owing to the antenna unit 11, the transmission unit 12, and the reception unit 13, predetermined wireless communication is performed. The first communication device 10 further includes the information detection unit 14, the information holding unit 15, and the information determination unit 16. In addition, owing to the information detection unit 14, the information holding unit 15, and the information determination unit 16, authentication is performed. The second communication device 20 may include the antenna unit 21, the transmission unit 22, and the reception unit 23. The transmission unit 22 and the reception unit 23 may be individually connected to a signal processing circuit (not illustrated). In addition, predetermined wireless communication may be performed using the antenna unit 21, the transmission unit 22, and the reception unit 23. The third communication device 30 may include an antenna unit 31, a transmission unit 32, and a reception unit 33, in the same way as the second communication device 20. The transmission unit 32 and the reception unit 33 may be individually connected to a signal processing circuit not illustrated. In addition, predetermined wireless communication may be performed using the antenna unit 31, the transmission unit 32, and the reception unit 33.

The first communication device 10 and the second communication device 20 may include close-range communication functions in addition to usual communication functions. The close-range communication may be communication performed with transmission power being reduced compared with usual communication, in order to perform communication in a close range of about several centimeters to about several tens of centimeters.

When a power supply has been turned on, the first communication device 10 may be put into a close-range communication mode, and may perform communication relating to authentication with the second communication device 20, owing to the close-range communication. In addition, at the time of the close-range communication, the first communication device 10 performs communication with reducing transmission power compared with usual communication. Therefore, even if the third communication device 30 exists in the vicinity of the first communication device 10, it may be possible to reduce the influence of an electromagnetic wave on the third communication device 30.

In an embodiment, a gesture used for performing authentication between the first communication device 10 and the second communication device 20 may be the same as the content described the above-described embodiment. However, in the communication system 200 according to the present embodiment, the third communication device 30 may exist in addition to the first communication device 10 and the second communication device 20, and it may also be possible for the third communication device 30 to perform authentication with the first communication device 10.

Therefore, different gestures may be used depending on a time when authentication is performed between the first communication device 10 and the second communication device 20 and a time when authentication is performed between the first communication device 10 and the third communication device 30. The reason is that when authentication is performed between the first communication device 10 and the second communication device 20, authentication may be prevented from being erroneously established between the first communication device 10 and the third communication device 30. In addition, a communication device the user 40 holds requests the user 40 to make a predetermined gesture so that, at that time, the user 40 misunderstands which gesture of a plurality of gestures is to be made.

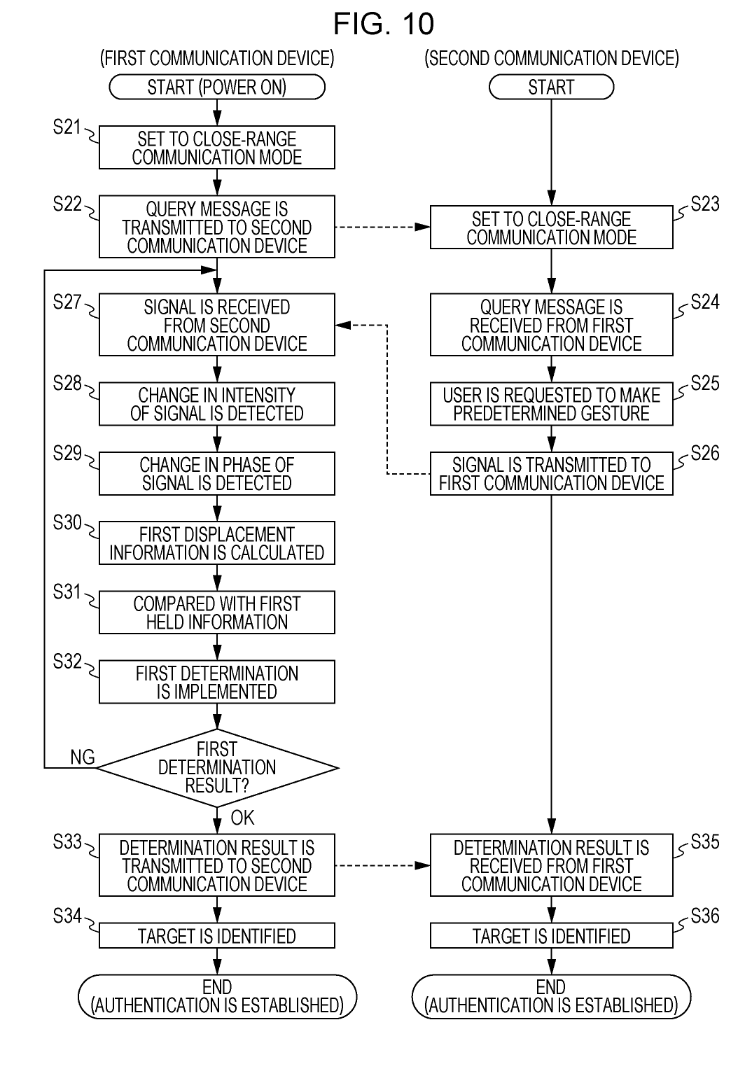

FIG. 10 is a flowchart illustrating a procedure for authentication according to an embodiment of the present disclosure.

As illustrated in FIG. 10, first, a power supply of the first communication device 10 may be turned on, and the first communication device 10 may be put into the close-range communication mode (step S21). Next, the first communication device 10 may transmit, to the second communication device 20, a query message used for requesting the user 40 to make a predetermined gesture (step S22).

In response to the step S22, the second communication device 20 may be put into the close-range communication mode (step S23). Next, the second communication device 20 may receive the query message from the first communication device 10 (step S24). Next, on the basis of the query message, the second communication device 20 may request the user 40 to make a predetermined gesture (step S25). Next, the second communication device 20 may transmit a signal to the first communication device 10 (step S26).

Next, in response to the step S26, the first communication device 10 may receive the signal from the second communication device 20 (step S27). In addition, along with a predetermined gesture the user 40 makes, the intensity and the phase of the signal the first communication device 10 receives change.

Next, the intensity change detection unit 14a in the information detection unit 14 may detect a change in the intensity of the reception signal (step S28). Next, the phase change detection unit 14b in the information detection unit 14 detects a change in the phase difference of the reception signal (step S29). Next, the operation unit 14c in the information detection unit 14 may calculate the first displacement information, from a change in the intensity of the reception signal and a change in the phase difference thereof (step S30). Next, the comparison unit 16a in the information determination unit 16 may compare the first displacement information with the first held information (step S31). Next, the determination unit 16b in the information determination unit 16 may implement a first determination used for determining whether or not to be connectable to the second communication device 20, from a comparison result in the step S31 (step S32).

When a first determination result obtained in the step S32 is “OK” (pairing is possible), the first communication device 10 may transmit the first determination result to the second communication device 20 (step S33). Next, the first communication device 10 may identify the second communication device 20 as a target of communication (step S34).

In response to the step S33, the second communication device 20 may receive the first determination result from the first communication device 10 (step S35). Next, the second communication device 20 may identify the first communication device 10 as a target of communication (step S36). In addition, authentication has been established between the first communication device 10 and the second communication device 20, and the wireless transfer of data may be started.

In accordance with such a procedure as described above, the first communication device 10 and the second communication device 20 perform authentication.

In an authentication method according to an embodiment, the first communication device 10 and the second communication device 20 may have the close-range communication functions, and the first communication device 10 may perform communication relating to authentication with the second communication device 20, owing to the close-range communication. Therefore, in the communication system 200 including the third communication device 30 in addition to the first communication device 10 and the second communication device 20, even if the third communication device 30 exists in the vicinity of the first communication device 10, it may be possible to reduce the influence of an electromagnetic wave on the third communication device 30. Furthermore, when the power supply has been turned on, the first communication device 10 may be put into the close-range communication mode. Therefore, it may not be necessary for the user to set to the close-range communication mode each time before an operation for authentication is started, and an operation may become simple.

In addition, in the authentication method according to an embodiment, the first communication device 10 may transmit, to the second communication device 20, the query message used for requesting a predetermined gesture from the user 40, the predetermined gesture being made with the second communication device 20 held. In addition, on the basis of the query message received from the first communication device 10, the second communication device 20 may request the predetermined gesture from the user 40. Therefore, in the communication system 200 including the third communication device 30 in addition to the first communication device 10 and the second communication device 20, even if a plurality of communication devices to serve as targets of authentication exist and authentication due to a plurality of gestures becomes necessary, the user 40 does not mistake a gesture used for performing authentication between the first communication device 10 and the second communication device 20.

Hereinafter, an embodiment of the present disclosure will be described with reference to drawings. In addition, the same symbol is assigned to a common portion shared with the above described embodiments, and the description thereof will be omitted.

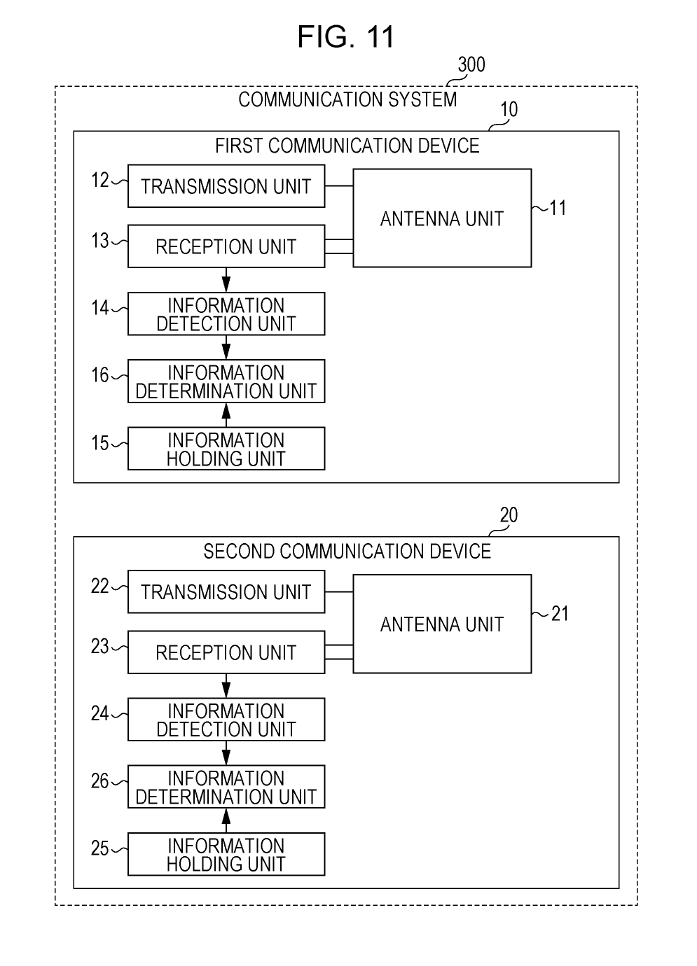

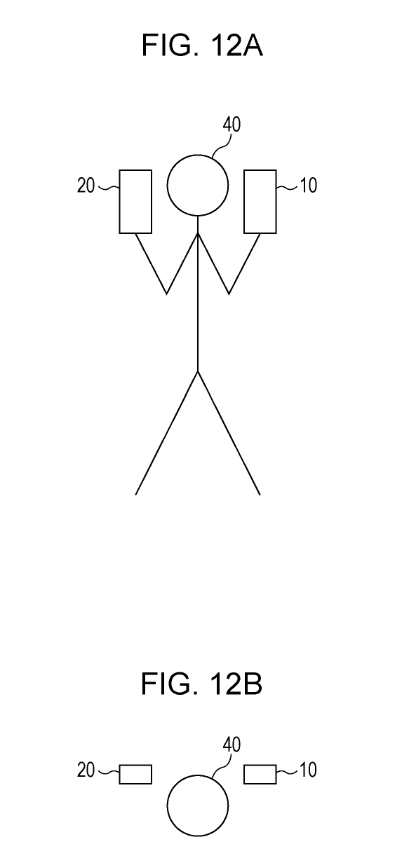

FIG. 11 is an explanatory diagram illustrating the configuration of a communication system according to an exemplary embodiment of the present disclosure. FIGS. 12A and 12B are explanatory diagrams illustrating the layout of communication devices illustrated in FIG. 11. FIG. 12A is a side view, and FIG. 125 is a top view.

As illustrated in FIG. 11 and FIGS. 12A and 12B, a communication system 300 according to an embodiment may include the first communication device 10 and the second communication device 20. The user 40 may stand with holding the first communication device 10 in the user's right hand (on the right side of FIG. 12A) and the second communication device 20 in the user's left hand (on the left side of FIG. 12A). In this way, the first communication device 10 and the second communication device 20 may be laid out on both sides of the user 40.

As the first communication device 10 and the second communication device 20, communication devices such as, for example, smartphones or PCs may be used. It may be possible for the first communication device 10 and the second communication device 20 to perform wireless communication such as the transfer of data, in cooperation with each other. In addition, when wireless communication is performed, it may be possible to perform authentication owing to a predetermined gesture the user 40 makes with holding the first communication device 10 and the second communication device 20.

The first communication device 10 may include the antenna unit 11, the transmission unit 12, and the reception unit 13. The transmission unit 12 and the reception unit 13 may be individually connected to a signal processing circuit (not illustrated). In addition, predetermined wireless communication may be performed using the antenna unit 11, the transmission unit 12, and the reception unit 13. The first communication device 10 further may include the information detection unit 14, the information holding unit 15, and the information determination unit 16. In addition, authentication may be performed using the information detection unit 14, the information holding unit 15, and the information determination unit 16. The second communication device 20 may include the antenna unit 21, the transmission unit 22, and the reception unit 23. The transmission unit 22 and the reception unit 23 may be individually connected to a signal processing circuit (not illustrated). In addition, predetermined wireless communication may be performed using the antenna unit 21, the transmission unit 22, and the reception unit 23. The second communication device 20 further may include an information detection unit 24, an information holding unit 25, and an information determination unit 26. In addition, authentication may be performed using the information detection unit 24, the information holding unit 25, and the information determination unit 26.

The first communication device 10 and the second communication device 20 may have so-called time-division communication functions for performing communication in a time division manner. Therefore, in a case where the first communication device 10 and the second communication device 20 communicate with each other, the second communication device 20 may perform reception when the first communication device 10 may perform transmission, the first communication device 10 may perform reception when the second communication device 20 may perform transmission, and the first communication device 10 and the second communication device 20 individually may repeat transmission and reception with respect to each other in a time division manner. In addition, the first communication device 10 and the second communication device 20 may perform transmission and reception using the same frequency.

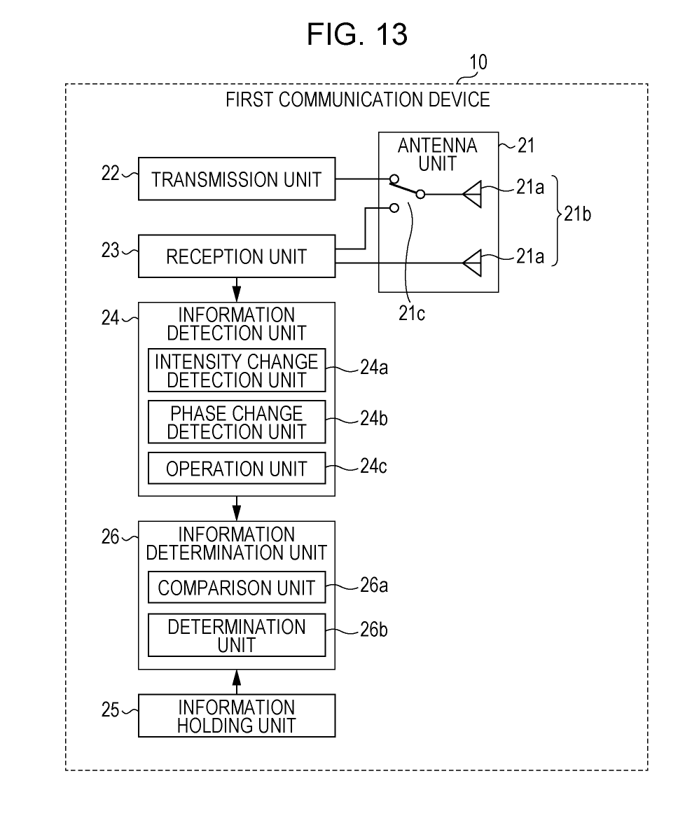

FIG. 13 is a block diagram illustrating the configuration of the second communication device illustrated in FIG. 11.

As illustrated in FIG. 13, the antenna unit 21 may include an array antenna 21b (second array antenna) including a plurality of antenna elements 21a, and a switching circuit 21c switching between a connection at the time of transmission and a connection at the time of reception. A spacing between the antenna elements 21a adjacent to each other in the array antenna 21b (hereinafter, simply referred to as an interelement spacing) may be set to be less than or equal to a half of the wavelength of a signal the first communication device 10 transmits. Since the function of the antenna unit 21 is the same as the function of the antenna unit 11, the description thereof will be omitted.

The information detection unit 24 may include an intensity change detection unit 24a, a phase change detection unit 24b, and an operation unit 24c. In addition, the information detection unit 24 may be connected to the reception unit 23, and may obtain, from the reception unit 23, information relating to the intensity and the phase of the reception signal. The intensity change detection unit 24a may monitor the information relating to the intensity of the reception signal, and may detect a change in the intensity of the reception signal. The phase change detection unit 24b may monitor the information relating to the phase difference of the reception signal, and may detect a change in the phase difference of the reception signal. The operation unit 24c may calculate second displacement information, from the information of the intensity change the intensity change detection unit 24a has detected and the information of the phase difference change the phase change detection unit 24b has detected. In the information detection unit 24, the second displacement information may be detected in this way.

The second displacement information may be information relating to the actual positional change of the first communication device 10 with respect to the second communication device 20. As the second displacement information, information may be used that relates to the relative distance change and the relative directional change of the first communication device 10 with respect to the second communication device 20, which are associated with a predetermined gesture the user 40 makes. In addition, the second displacement information is not a so-called analog electrical signal, and is digitally quantified information. In addition, the second displacement information also may be corrected so as to enhance the accuracy of detection, or the information thereof may also be processed so as to be easily compared with other information.

The information holding unit 25 may hold second held information preliminarily set. Such holding of information may be performed using, for example, a method causing a recording device such as a hard disk device to record, a method causing a storage device such as a semiconductor memory device to store, or a method carrying out an operation each time in accordance with a predetermined procedure.

The second held information may be information to be compared with the second displacement information. As the second held information, information may be used that relates to the relative distance change and the relative directional change of the first communication device 10 with respect to the second communication device 20, which may be anticipated to serve as a predetermined gesture. In addition, like the second displacement information, the second held information may be digitally quantified information.

The information determination unit 26 may include a comparison unit 26a and a determination unit 26b. In addition, the information determination unit 26 may be connected to the information detection unit 24, and obtains the second displacement information. In addition, the information determination unit 26 may be connected to the information holding unit 25, and may obtain the second held information. The comparison unit 26a may compare the obtained second displacement information and the second held information with each other. From the result of a comparison the comparison unit 26a has performed, the determination unit 26b may determine whether or not a predetermined gesture has been made, and determines whether or not to be connectable to the first communication device 10.

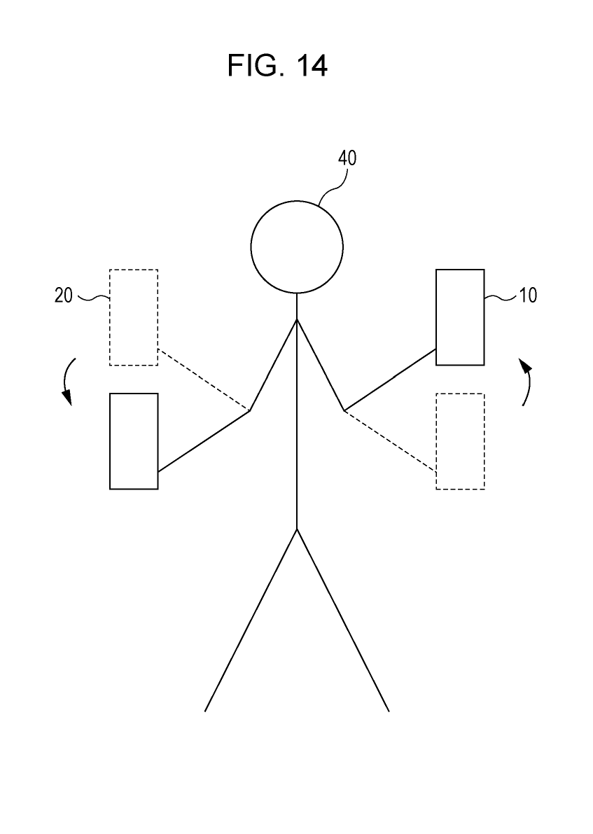

FIG. 14 is an explanatory diagram illustrating an example of a gesture motion according to an embodiment of the present disclosure. As illustrated in FIGS. 12A and 12B, the user 40 may stand with holding the first communication device 10 in the user's right hand (on the right side of FIG. 12A) and the second communication device 20 in the user's left hand (on the left side of FIG. 12A). A signal may be transmitted from the first communication device 10, and the second communication device 20 may receive that signal. In addition, a signal may be transmitted from the second communication device 20, and the first communication device 10 may receive that signal. In addition, as illustrated in FIG. 14, the user 40 may make a gesture such as swinging down the first communication device 10 from top right to bottom right and swinging up the second communication device 20 from bottom left to top left almost at the same time as that. Along with such a gesture of the user 40, the first communication device 10 and the second communication device 20 may make substantially point-symmetric motions with respect to each other with one point as a center, the one point existing in the vicinity of the front (neighborhood space) of the user 40.

At this time, the relative distance change of the second communication device 20 with respect to the first communication device 10 may become a change approximately twice as large as a case where only the second communication device 20 has moved. In addition, the relative distance change of the first communication device 10 with respect to the second communication device 20 may become a change approximately twice as large as a case where only the first communication device 10 has moved. As a result, even if the gesture of the user 40 is a small motion, it may become easy to detect the first displacement information and the second displacement information.

Furthermore, the relative distance change of the second communication device 20 with respect to the first communication device 10 and the relative distance change of the first communication device 10 with respect to the second communication device 20 may become changes whose magnitudes are approximately equal to each other. In addition, the relative directional change of the second communication device 20 with respect to the first communication device 10 and the relative directional change of the first communication device 10 with respect to the second communication device 20 may become changes whose directions are opposite to each other. Therefore, the first displacement information and the second displacement information may become pieces of similar information whose distance changes may be approximately equal to each other and whose directional changes may be opposite in direction to each other. As a result, since, using the first displacement information and the second displacement information, which are similar to each other, it may be possible to perform the determination of a gesture, the determination may become simple.

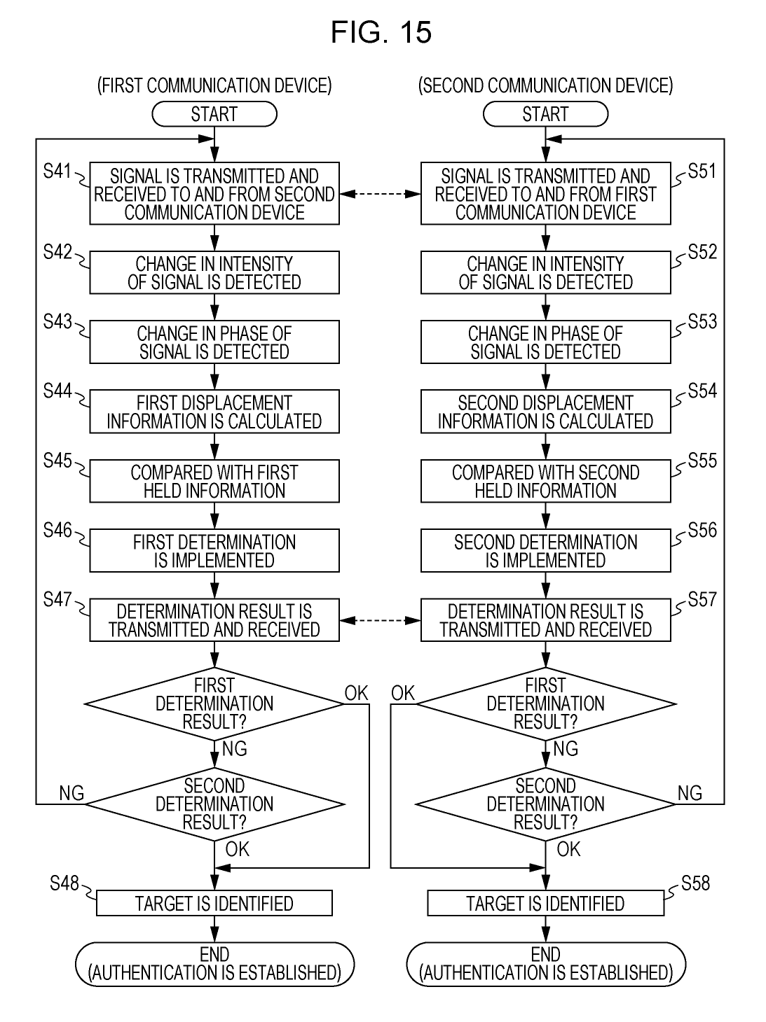

FIG. 15 is a flowchart illustrating a procedure for authentication according to an exemplary embodiment of the present disclosure.

As illustrated in FIG. 15, first, the first communication device 10 may transmit a signal to the second communication device 20, and may receive a signal from the second communication device 20 (step S41). In addition, along with a predetermined gesture the user 40 makes, the intensity and the phase difference of the signal the first communication device 10 receives may change.

Next, the intensity change detection unit 14a in the information detection unit 14 may detect a change in the intensity of the reception signal (step S42). Next, the phase change detection unit 14b in the information detection unit 14 may detect a change in the phase difference of the reception signal (step S43). Next, the operation unit 14c in the information detection unit 14 may calculate the first displacement information, from a change in the intensity of the reception signal and a change in the phase difference thereof (step S44). Next, the comparison unit 16a in the information determination unit 16 may compare the first displacement information with the first held information (step S45). Next, the determination unit 16b in the information determination unit 16 may implement first determination used for determining whether or not to be connectable to the second communication device 20, from a comparison result in the step S45 (step S46). Next, the first communication device 10 may transmit a first determination result to the second communication device 20, and may receive a second determination result from the second communication device 20 (step S47).

When the first determination result obtained in the step S46 is “OK” (connectable), the first communication device 10 may identify the second communication device 20 as a target of communication (step S48). In addition, authentication has been established between the first communication device 10 and the second communication device 20, and the wireless transfer of data may be started.

When the first determination result obtained in the step S46 is “NG” (non-connectable) and the second determination result obtained in the step S47 is “OK” (connectable), the first communication device 10 also identifies the second communication device 20 as a target of communication (step S48). In addition, authentication has been established between the first communication device 10 and the second communication device 20, and the wireless transfer of data may be started.

When the first determination result obtained in the step S46 is “NG” (non-connectable) and the second determination result obtained in the step S47 is also “NG” (non-connectable), authentication between the first communication device 10 and the second communication device 20 is not established, and the first communication device 10 may return to the step S41, and may repeat transmission and reception to and from the second communication device 20 again.

As illustrated in FIG. 15, almost simultaneously with the first communication device 10, the second communication device 20 also may perform authentication with the first communication device 10. First, in response to the step S41, the second communication device 20 may transmit a signal to the first communication device 10, and may receive a signal from the first communication device 10 (step S51).

Next, the intensity change detection unit 24a in the information detection unit 24 may detect a change in the intensity of the reception signal (step S52). Next, the phase change detection unit 24b in the information detection unit 24 may detect a change in the phase difference of the reception signal (step S53). Next, the operation unit 24c in the information detection unit 24 may calculate the second displacement information, from a change in the intensity of the reception signal and a change in the phase difference thereof (step S54). Next, the comparison unit 26a in the information determination unit 26 may compare the second displacement information with the second held information (step S55). Next, the determination unit 26b in the information determination unit 26 may implement second determination used for determining whether or not to be connectable to the first communication device 10, from a comparison result in the step S55 (step S56). Next, in response to the step S47, the second communication device 20 may transmit the second determination result to the first communication device 10, and may receive the first determination result from the first communication device 10 (step S57).

When the first determination result obtained in the step S57 is “OK” (connectable), the second communication device 20 may identify the first communication device 10 as a target of communication (step S58). In addition, authentication has been established between the first communication device 10 and the second communication device 20, and the wireless transfer of data may be started.

When the first determination result obtained in the step S57 is “NG” (non-connectable) and the second determination result obtained in the step S56 is “OK” (connectable), the second communication device 20 also may identify the first communication device 10 as a target of communication (step 358). In addition, authentication has been established between the first communication device 10 and the second communication device 20, and the wireless transfer of data may be started.

When the first determination result obtained in the step S57 is “NG” (non-connectable) and the second determination result obtained in the step S56 is also “NG” (non-connectable), authentication between the first communication device 10 and the second communication device 20 is not established, and the second communication device 20 may return to the step S51, and may repeat transmission and reception to and from the first communication device 10 again.

In accordance with such a procedure as described above, the first communication device 10 and the second communication device 20 may perform authentication. In addition, if it may be possible for one communication device of the first communication device 10 and the second communication device 20 to identify the other communication device as a target of communication, authentication between the first communication device 10 and the second communication device 20 may be established.

In an authentication method according to an embodiment, in addition to the first communication device 10, the second communication device 20 also may receive a signal the first communication device 10 transmits, may detect the second displacement information relating to the positional change of the first communication device 10, from a change in the intensity of the received signal and a change in the phase difference thereof, may perform the second determination by comparing the second displacement information with the preliminarily set second held information, and may identify the first communication device 10 as a target of communication on the basis of the result of the second determination. In addition, at least one communication device of the first communication device 10 and the second communication device 20 may identify the other communication device as a target of communication, and hence, authentication between the first communication device 10 and the second communication device 20 may be established. Therefore, even if one of the first communication device 10 and the second communication device 20 has failed in identifying a target of communication, when the other has succeeded, authentication between the first communication device 10 and the second communication device 20 may be established. As a result, it may be possible to more reliably perform authentication.

In addition, the first displacement information may be information relating to the relative distance change and the relative directional change of the second communication device 20 with respect to the first communication device 10. In addition, the second displacement information may be information relating to the relative distance change and the relative directional change of the first communication device 10 with respect to the second communication device 20. Therefore, owing to information easily determining motion states such as a change in a distance and a change in a direction, it may be possible for the first communication device 10 and the second communication device 20 to determine whether or not a predetermined gesture has been made. Furthermore, the first displacement information and the second displacement information are not so-called analog electrical signals but may be pieces of digitally quantified information. Therefore, it may be easy to perform a correction so as to enhance the accuracy of detection or it may be easy to process so as to easily compare with other information. As a result, it may become easy to determine whether the first communication device 10 and the second communication device 20 are connectable to each other.

In addition, the first communication device 10 may include the array antenna 11b (first array antenna) including the plural antenna elements 11a. Therefore, when receiving a signal the second communication device 20 transmits, it may be possible to receive at least two signals whose phases are shifted in response to an interelement spacing. It may be possible to estimate a direction from which the signal arrives, from a phase difference between such signals. Furthermore, the interelement spacing of the array antenna 11b may be less than or equal to a half of the wavelength of a signal the second communication device 20 transmits. Therefore, since it may be possible to unambiguously estimate a direction from which the signal arrives, it may be easy to estimate the direction. Using such an array antenna 11b, it may be possible for the first communication device 10 to easily detect the relative directional change of the second communication device 20 with respect to the first communication device 10, from a change in the phase difference between the received signals.

In the same way, the second communication device 20 may include the array antenna 21b (second array antenna) including the plural antenna elements 21a. Furthermore, the interelement spacing of the array antenna 21b may be less than or equal to a half of the wavelength of a signal the first communication device 10 transmits. Using such an array antenna 21b, it may be possible for the second communication device 20 to easily detect the relative directional change of the first communication device 10 with respect to the second communication device 20, from a change in the phase difference between the received signals.

In addition, the first communication device 10 and the second communication device 20 may repeat transmission and reception with respect to each other in a time division manner. Therefore, it may be possible for the first communication device 10 and the second communication device 20 to continuously monitor the intensities and the phases of received signals. As a result, it may be possible to reduce erroneous determination due to an omission of determination. In addition, using the same frequency, it may be possible for the first communication device 10 and the second communication device 20 to perform transmission and reception. Therefore, it may be possible for the first communication device 10 and the second communication device 20 to estimate directions from which received signals arrive, under the operation condition that the same frequency is used. As a result, it may become easy to detect the first displacement information and the second displacement information.

In addition, in the authentication method according to the present embodiment, the positional change of the first communication device 10 and the positional change of the second communication device 20 are made using a predetermined gesture the user 40 makes with holding the first communication device 10 and the second communication device 20, and the predetermined gesture may be such a gesture that the first communication device 10 and the second communication device 20 make substantially point-symmetric motions with respect to each other with one point as a center, the one point existing in the vicinity of the front (neighborhood space) of the user 40. Therefore, the relative distance change of the second communication device 20 with respect to the first communication device 10 may become a change approximately twice as large as a case where only the second communication device 20 has moved. In addition, the relative distance change of the first communication device 10 with respect to the second communication device 20 may become a change approximately twice as large as a case where only the first communication device 10 has moved. As a result, even if the gesture of the user 40 is a small motion, it may become easy to detect the first displacement information and the second displacement information.

Furthermore, the relative distance change of the second communication device 20 with respect to the first communication device 10 and the relative distance change of the first communication device 10 with respect to the second communication device 20 become changes whose magnitudes are approximately equal to each other. In addition, the relative directional change of the second communication device 20 with respect to the first communication device 10 and the relative directional change of the first communication device 10 with respect to the second communication device 20 may become changes whose directions are opposite to each other. Therefore, the first displacement information and the second displacement information may become pieces of similar information whose distance changes are approximately equal to each other and whose directional changes are opposite in direction to each other. As a result, since, using the first displacement information and the second displacement information, which are similar to each other, it may be possible to perform the determination of a gesture, the determination may become simple.

Embodiments of the present invention are not limited to the above-mentioned embodiments, and may also be arbitrarily modified without departing from the scope of the present invention.

For example, the first communication device 10 may also estimate the arrival direction of a signal owing to a mechanism other than the array antenna 11b. For example, in place of the array antenna 11b, two antennas whose intended purposes are different may also be utilized, and used for estimating the arrival direction of a signal by correcting the intensities or the phases of signals the two antennas have individually received. In that case, the array antenna 11b may become unnecessary, and it may be possible to make a configuration simpler.

In addition, for example, the first communication device 10 may include a plurality of microphones, the second communication device 20 may include at least one speaker, and communication relating to authentication may also be performed using a sound signal in place of an electromagnetic wave signal. In addition, from a change in the intensity of the sound signal and a change in the phase difference thereof, the first displacement information may also be detected. Also in that case, the array antenna 11b may become unnecessary, and it may be possible to make a configuration simpler.

In addition, for example, in the first communication device 10, the number of the antenna elements 11a the array antenna 11b includes may also be further increased, and set to, for example, three or more. In addition, for example, layout may also be adopted where the three antenna elements 11a are located at the three vertices of a triangle, and layout may also be adopted where the four antenna elements 11a are located at the four vertices of a quadrangle. In that case, it may be possible to more correctly estimate a direction from which a signal arrives.

In addition, for example, the first displacement information may also be the amount of change in the intensity of an actual signal and the amount of change in the phase difference thereof, which are associated with a predetermined gesture, and the first held information may also be the anticipated values of the amount of change in the intensity of a signal and the amount of change in the phase difference thereof, which are anticipated from the predetermined gesture. In the case of a simple gesture motion, owing to such first displacement information and first held information, it may also be possible to determine whether or not the predetermined gesture has been made.

In addition, for example, the first displacement information may also be information relating to the positional changes of the second communication device 20 at a plurality of times. In that case, it may become possible to perform authentication compatible with a complex gesture in which a plurality of motions are combined.

What is claimed is:

1. An authentication method between a first communication device and a second communication device, the first and second communication devices being among a plurality of communication devices, the authentication method comprising:
receiving, at the first communication device, a signal transmitted from the second communication device,
detecting, by the first communication device, first displacement information relating to a positional change of the second communication device, from a change in an intensity of the received signal and a change in a phase difference thereof,
performing, by the first communication device, a first determination by comparing the first displacement information with first held information preliminarily set, and
identifying, by the first communication device, the second communication device as a target of communication on the basis of a result of the first determination.

2. The authentication method according to claim 1, wherein
the first displacement information is quantified information relating to a relative distance change and a relative directional change of the second communication device with respect to the first communication device.

3. The authentication method according to claim 1, wherein
the first communication device includes a first array antenna including a plurality of antenna elements, and
a spacing between the antenna elements adjacent to each other in the first array antenna is set to be less than or equal to a half of a wavelength of a signal the second communication device transmits.

4. The authentication method according to claim 1, wherein
the first communication device and the second communication device have close-range communication functions, and
the first communication device is put into a close-range communication mode when a power supply has been turned on, and
performs communication relating to authentication with the second communication device, owing to close-range communication.

5. The authentication method according to claim 1, further comprising:
transmitting, by the first communication device, to the second communication device, a query message used for requesting a user to make a predetermined gesture with holding the second communication device, wherein
the second communication device requests a user of the second communication device to make the predetermined gesture, on the basis of the query message received from the first communication device, and
detecting, by the first communication device, the first displacement information from the positional change of the second communication device, the positional change of the second communication device being associated with the predetermined gesture.

6. The authentication method according to claim 1, further comprising:
receiving, by the second communication device, a signal transmitted by the first communication device,
detecting, by the second communication device, second displacement information relating to a positional change of the first communication device, from a change in an intensity of the received signal and a change in a phase difference thereof,
performing, by the second communication device, second determination by comparing the second displacement information with second held information preliminarily set, and identifying, by the second communication device, the first communication device as a target of communication on the basis of a result of the second determination.

7. The authentication method according to claim 6, wherein
the first displacement information is quantified information relating to a relative distance change and a relative directional change of the second communication device with respect to the first communication device, and
the second displacement information is quantified information relating to a relative distance change and a relative directional change of the first communication device with respect to the second communication device.

8. The authentication method according to claim 6, wherein
the first communication device includes a first array antenna including a plurality of antenna elements,
a spacing between the antenna elements adjacent to each other in the first array antenna is set to be less than or equal to a half of a wavelength of a signal the second communication device transmits,
the second communication device includes a second array antenna including a plurality of antenna elements, and
a spacing between the antenna elements adjacent to each other in the second array antenna is set to be less than or equal to a half of a wavelength of a signal the first communication device transmits.

9. The authentication method according to claim 6, further comprising:
performing, by the second communication device, reception when the first communication device performs transmission, and
performing, by the first communication device, reception when the second communication device performs transmission, wherein
the first communication device and the second communication device individually repeat transmission and reception with respect to each other in a time division manner.

10. The authentication method according to claim 6, wherein
the positional change of the first communication device and the positional change of the second communication device are made based on a predetermined gesture a respective user makes with holding the first communication device and the second communication device, and
the predetermined gesture is such a gesture that the first communication device and the second communication device make substantially point-symmetric motions with respect to each other with one point as a center, the one point existing in a neighborhood space of the user.
